(19) United States
(12) Patent Application Publication
(10) Pub. No.: US 2026/0254548 A1
(43) Pub. Date: Aug. 27, 2026

(54) Selecting a Best Available Clock for Synchronization Recovery

(71) Applicant: Ciena Corporation, Hanover, MD (US)

(72) Inventors: Amit Kumar Choudhary, New Delhi (IN); Krishan Singh, Rewari (IN); Sharad Kumar Srivastava, Varanasi (IN); Hirdesh Srivastava, Vatika (IN)

(73) Assignee: Ciena Corporation, Hanover, MD (US)

(21) Appl. No.: 19/175,183

(22) Filed: Apr. 10, 2025

(30) Foreign Application Priority Data
Feb. 26, 2025 (IN) 202541016817

(51) Int. Cl. H04J 3/06

(52) U.S. Cl. CPC H04J 3/0667; H04J 3/0644

(57) ABSTRACT

Systems and methods are provided for selecting a clock source for synchronization recovery. According to one implementation, a method includes a step of receiving Master clock signals and source recovery indicators from upstream branches of a communications system, each source recovery indicator corresponding to a respective Master clock signal. Furthermore, the method includes a step of utilizing a prioritization strategy to prioritize the Master clock signals based on information derived from the source recovery indicators. During synchronization recovery, the method also includes a step of selecting one of the Master clock signals based on the prioritization strategy to act as a temporary synchronization source in a downstream branch of the communications system.

### FIELD OF THE DISCLOSURE

The present disclosure relates generally to ensuring synchronization in communication networks. More particularly, the present disclosure relates to systems and methods for enhancing holdover or recovery in a network of synchronized clocks, such as a Precision Time Protocol (PTP) network, by selecting a best available clock source, such as a SyncE clock source.

### BACKGROUND

The Standardization Sector of the International Telecommunications Union (ITU) has published a number of Recommendations regarding time, frequency, and phase synchronization in telecommunications networks. In particular, this family of synchronization standards may include at least ITU-T Recommendations G.8264, G.8265.1, G.8271, G.8271.1, G.8271.2, G.8272, G.8272.1, G.8272.2, G.8273, G.8273.2, G.8273.3, G.8273.4, G.8275, G.8275.1, G.8275.2, among others, plus amendments thereto. In addition, the Institute of Electrical and Electronics Engineers (IEEE) has published versions of a Precision Time Protocol (PTP) in IEEE 1588 (i.e., IEEE 1588-2002, 1588-2008, 1588-2019) defining clock synchronization in telecommunications networks. The content of these synchronization recommendations, protocols, and standards is incorporated by reference in the present disclosure.

### BRIEF SUMMARY

The present disclosure relates to systems and methods for synchronization recovery or holdover in a network of synchronized clocks, for example involving Precision Time Protocol (PTP) network, Synchronous Ethernet (SyncE) network, or a combination thereof. According to one implementation, a method for selecting a backup clock source includes a step of receiving Master clock signals and source recovery indicators from upstream branches of a communications system, where each source recovery indicator corresponds to a respective Master clock signal. The method also includes a step of utilizing a prioritization strategy to prioritize the Master clock signals based on information derived from the source recovery indicators. During synchronization recovery, the method further includes a step of selecting one of the Master clock signals based on the prioritization strategy to act as a temporary synchronization source in a downstream branch of the communications system.

The method may be executed, for example, by a clock selection unit of a Network Element (NE) that is arranged between the upstream branches and downstream branch of the communications system. The NE, for example, may be a Telecom-Boundary Clock (T-BC) device, an Ethernet Equipment Clock (EEC) device, or another suitable type of branching network component.

In some embodiments, the source recovery indicators may be communicated from Master nodes in the upstream branches via an Ethernet Synchronization Message Channel (ESMC) defined in ITU-T Recommendation G.8264. The source recovery indicators, for example, may be inserted by Master nodes into previously unused Type, Length, Value (TLV) bits of a Protocol Data Unit (PDU) of the ESMC. In some embodiments, the source recovery indicators may include two bits in the PDU of the ESMC to designate a first state for indicating a deference to a Quality Lever (QL)-based selection, a second state indicating a frequency recovery from a higher-priority physical layer source, and a third state indicates a frequency recovery from a lower-priority packet source.

According to various implementations, the Master clock signals may be identified as being obtained from Synchronous Ethernet (SyncE) sources. The source recovery indicators, for example, may include information regarding a type of frequency source from which the corresponding Master clock signals originate, whereby the type of frequency source may be defined by a medium over which the frequency source is conveyed. The transportation medium, for example, may be a physical layer or a packet layer, where the physical layer may be defined by Ethernet communication according to ITU-T Recommendation G.8275.1 and the packet layer may be defined by Internet Protocol (IP) and/or Multiprotocol Label Switching (MPLS) communication according to ITU-T Recommendation G.8275.2.

The clock selection unit, in some embodiments, may be further configured to temporarily switch to a selected Master clock signal for recovery of clock synchronization when an original clock source between a grand master (GM) clock and a Precision Time Protocol (PTP) client is unavailable. The clock selection unit may be further configured to recover accurate frequency, time, and phase for alignment of the downstream branch with a Grand Master (GM) clock. The clock selection unit, in some embodiments, may further be configured to perform a frequency source recovery by prioritizing a physical-based frequency source over a packet-based frequency source. The physical-based frequency source may be communicated over a Full Timing Support (FTS) upstream branch, and the packet-based frequency source may be communicated over a Partial Timing Support (PTS) upstream branch. A first branch of the upstream branches, for example, may include an Inter-Working Function (IWF) component that converts Partial Timing Support (PTS) to Full Timing Support (FTS), where the first branch might be prone to high Packet Delay Variation (PDV), and where conversion from PTS to FTS is hidden from the downstream branch without knowledge of the source recovery indicators.

According to some embodiments, the clock selection unit may further be configured to default to a clock selection based on Quality Level (QL) before utilizing the prioritization strategy, where the clock selection unit may then perform the prioritization strategy when the QL of the upstream branches is the same. Alternatively, the clock selection unit may be configured to default to a clock selection based on QL after utilizing the prioritization strategy, where a QL analysis may be performed when execution of the prioritization strategy for the upstream branches results in equal priorities. In some embodiments, the method may be defined whereby the process of utilizing the prioritization strategy and selecting a Master clock signal may be configured as an enhancement to the Best time Transmitter Clock Algorithm (BTCA).

### BRIEF DESCRIPTION OF THE DRAWINGS

The present disclosure is detailed through various drawings, where like components or steps are indicated by identical reference numbers for clarity and consistency.

FIG. 1 is a diagram illustrating a branched communication system in which a clock is selected for synchronization recovery, according to various embodiments.

FIG. 2 is a diagram illustrating another branched communication system in which a clock is selected for synchronization recovery, according to various embodiments.

FIG. 3 is a chart showing the Protocol Data Unit (PDU) designation for the Ethernet Synchronization Message Channel (ESMC) as defined in ITU-T Rec. G.8264.

FIG. 4 is a table showing a two-bit designation for indicating characteristics of a frequency recovery source of a master node within previously unused the ESMC of ITU-T Rec. G.8264, according to various embodiments.

FIG. 5 is a block diagram illustrating a Network Element (NE) operating in a communications network and configured to select a frequency recovery clock from multiple upstream master nodes, according to various embodiments.

FIG. 6 is a flow diagram illustrating a method for selecting a backup clock source, according to various embodiments.

### DETAILED DESCRIPTION

In a packet network, Network Elements (NEs) (e.g., switch, router, node, etc.) uses the Precision Time Protocol (PTP) to achieve timing synchronization by exchanging timestamped packets with PTP masters and slaves in the network. The protocol ensures accurate synchronization of clocks across NEs by compensating for delays introduced by packet transmission. An NE may act as either a PTP boundary clock or a PTP transparent clock, where boundary clocks synchronize with an upstream source and distribute timing downstream, while transparent clocks measure and correct for delay variations within the network. In particular, this precise timing is critical in 5G applications, where Ultra-Reliable Low-Latency Communication (URLLC), Time-Sensitive Networking (TSN), and massive Machine-Type Communications (mMTC) demand highly accurate synchronization to meet stringent latency and jitter requirements.

Timing in these networks originates from Primary Reference Clocks (PRCs), which are highly stable and accurate clock sources compliant with ITU-T standards, such as those described herein. PRCs typically derive their timing from atomic clocks or Global Positioning Satellite (GPS) systems, providing the foundation for network-wide synchronization. Secondary Synchronization Units (SSU-A clocks) act as intermediate timing sources that maintain synchronization during short interruptions in PRC availability. These clocks, designed with holdover capabilities, ensure continuity and accuracy of timing even in challenging scenarios, whereby “holdover” refers to a “recovery” time period between well-defined synchronization events. Together, PTP-enabled switches, PRCs, and SSU-A clocks enable the precise timing required for the seamless functioning of advanced 5G networks.

The duration that a node can remain in holdover is directly determined by the quality of its frequency source. A node with a clock traceable to a PRC will typically exhibit slower time deviation compared to one relying on an SSU-A clock, which is less stable. In scenarios where two interconnected nodes lose connectivity to the Grandmaster Clock (GMC), the network protocol dictates that one node assumes the role of Master while the other becomes a Slave. The Slave node synchronizes with the Master and thus inherits the same rate of deviation as the Master. However, challenges arise when the node selected as the Master does not have a robust frequency backup and deviates rapidly. In such a case, even the Slave node, despite having a better frequency source, would deviate at the same accelerated rate as the Master, leading to suboptimal network synchronization. This issue is a direct consequence of the Best time Transmitter Clock Algorithm (BTCA) defined in ITU-T G.8275.2, Amendment 1. The BTCA selects the Master based on predefined criteria, which may not always account for the quality of the frequency backup, potentially compromising the stability and accuracy of the overall network timing during holdover.

IEEE 1588 defines PTP, enabling precise synchronization of clocks across networked devices with sub-microsecond accuracy. The standard outlines the mechanisms for clock synchronization, including the exchange of timestamped messages and the BTCA algorithm for selecting the optimal clock within a network. The 2019 revision of IEEE 1588 (i.e., IEEE 1588-2019) introduces enhancements like improved accuracy, robustness against network delays, and security features to protect against timing attacks. A grandmaster clock in a PTP network serves as the primary source of accurate time for all devices within that network. It is the topmost clock selected through the BTCA algorithm, which assesses all clocks based on criteria like priority levels, clock class, accuracy, and stability to determine the most qualified one. Once designated, the Grandmaster clock distributes its precise time information to subordinate clocks by sending timestamped messages, ensuring that all devices are synchronized.

In mobile networking (e.g., Radio Access Networks (RANs), etc.), the Global Navigation Satellite System (GNSS) can be used as a primary source for synchronization. Utilizing GNSS to synchronize radios and Base Band Units (BBUs) at a cell site has been a common method in mobile networks. It should be noted that there is a need for suitable network engineering practices to enable synchronization via transport network demands. However, with the evolution of the 5G, it has been discovered that using only GNSS clocks is not a legitimate solution to synchronize a network, specifically since the GNSS is subject to changes due to atmospheric conditions.

In PTP and its associated telecom profiles (e.g., ITU-T Recs. G.8265.1, G.8275.1, G.8275.2, etc.), packets can be carried between a PTP Grand Master (GM) and PTP clients. Communications traffic can traverse over either 1) an Ethernet network, or 2) an Internet Protocol (IP) and/or Multiprotocol Label Switching (MPLS) network (e.g., referred to herein as an “IP/MPLS network”). That is, packets can be transmitted over Ethernet networks in a Fully Time Aware (FTA) manner with NEs having Full Timing Support (FTS). Alternatively, packets can be transmitted over IP/MPLS networks in a Partially Time Aware (PTA) manner with NEs having Partial Timing Support (PTS). Also, PTP clients can use timestamps received through PTP to recover accurate frequency, time, and phase for alignment with PTP GM clocks. ITU-T Rec. G.8265.1 defines recovery of frequency and Recs. G.8275.1 and G.8275.2 define recovery of phase and time. This process may be assisted by recovered frequency from electrical sources like Synchronous Ethernet (SyncE), Building Integrated Timing Supply (BITS), etc.

In some deployment scenarios, PTP can be used as a back up to some other time sources like GNSS as a measure of providing resilience to network timing architecture. ITU-T Rec. G.8275.1 describes this architecture, and Rec. G.8275.2 is referred to as an Assisted PTS (A-PTS) architecture. It allows a non PTP time source (e.g., GNSS) to be fed into PTP state machines as a logical PTP port (or virtual PTP port) so that a clock selection algorithm, such as Best time Transmitter Clock Algorithm (BTCA), can consider it as a recovery candidate while selecting the best available time clock sources.

### System With Clock Synchronization Recovery

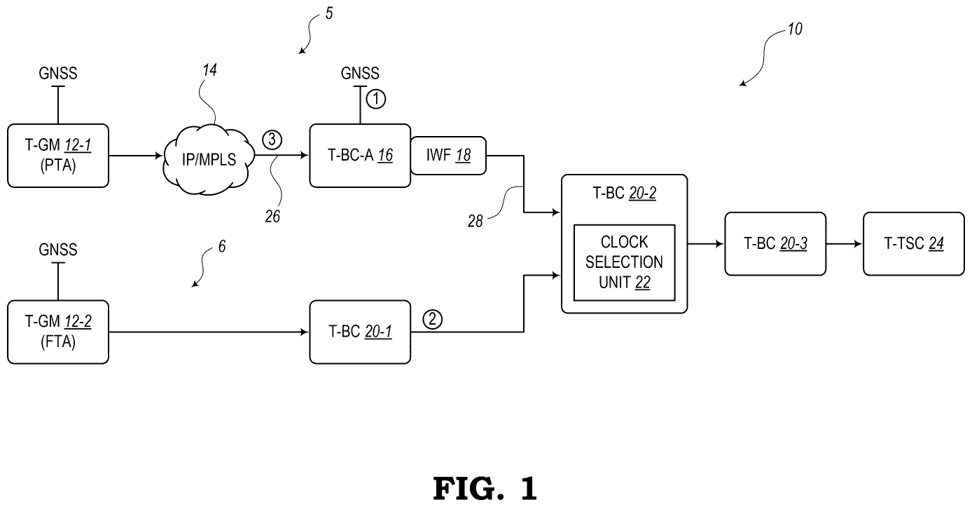

FIG. 1 is a diagram illustrating an embodiment of a branched communication system 10 in which a clock is selected from upstream Masters for synchronization recovery. As shown in FIG. 1, the branched communication system 10 includes a first upstream branch comprising a first Telecom-Grand Master (T-GM) node 12-1, an IP/MPLS network 14, a Telecom-Boundary Clock-Assisted (T-BC-A) node 16, and an Inter-Working Function (ITW) module 18. The branched communication system 10 includes a second upstream branch comprising a second T-GM node 12-2 and a first Telecom-Boundary Clock (T-BC) node 20-1. In addition, the two branches of the branched communication system 10 are joined at a downstream branch comprising a second T-BC node 20-2 having a clock selection unit 22, a third T-BC node 20-3, and a Telecom-Time Slave Clock (T-TSC) node 24. The clock selection unit 22 of the second T-BC node 20-2 is configured to determine which upstream clock is to be selected to provide the best synchronization results for the downstream branch during a recovery process.

In the first (PTS) branch, the IP/MPLS network 14 may provide a G.8275.2 (PTS) PTP backup clock to the T-BC node 16 over line 26. After processing by the IWF module 18, output from the T-BC-A node 16 may be configured to provide a SyncE output from the IWF module 18 to the second T-BC node 20-2 over line 28. Thus, the second T-BC node 20-2 is supplied with two SyncE clock sources from the two upstream branches. However, the second T-BC node 20-2 would not know where these SyncE sources come from without using the strategies described herein.

In general, PTP-based network clocking is either driven by a Fully Time Aware (FTA) architecture with Full Timing Support (FTS) using a G.8275.1 profile or alternatively by a Partially Time Aware (PTA) architecture with Partial Timing Support (PTS) or Assisted PTS (A-PTS) using a G.8275.2 profile. However, selection of a best clock can become relatively complicated in systems when both these architectures are mixed using Inter-Working Functions (IWFs), such as in the scenario shown in the branched communication system 10 in FIG. 1 where the first branch 5 is configured for PTS over the IP/MPLS network 14 and the second branch 6 is configured for FTS over an Ethernet network. By utilizing the IWFs, the PTS of the first PTA branch can be translated from this PTS profile to the FTS profile.

Hence, the branched communication system 10 includes one portion (i.e., the first branch 5) that is based on the PTS architecture as described in G.8275.2 and another portion (i.e., the second branch 6) that is based on the FTS architecture as described in G.8275.1. However, the T-BC-A node 16 uses the IWF module 18 to implement an IWF that is configured to essentially translate PTP profile from G.8275.2 to G.8275.1. This means that, for the downstream branch (i.e., starting with the second T-BC node 20-2), both of the two upstream branches appear to be FTS-based since they both provide a clock source based on the G.8275.1 profile. It should be noted at this point, however, that the first branch 5 originates as a PTS branch that is eventually converted to FTS, while the second branch 6 includes FTS throughout the entire branch.

One problem that a conventional clock selection algorithm may have in such as network (e.g., the branched communication system 10) is that a clock may be selected that is not actually the “best” clock. However, the clock selection unit 22 of the second T-BC node 20-2 is configured to use a strategy that has not been considered in conventional systems. In particular, a downstream node in a conventional system is not privy to where upstream clocks come from. According to the systems and methods of the present disclosure, the upstream branches are configured to communicate clock source information to the downstream branching node (e.g., the second T-BC node 20-2). In response to receiving information about the upstream clocks, the clock selection unit 22 is configured to prioritize various characteristics to better determine the best available clock for synchronization during a recovery process.

Again, a problem with conventional systems is that a branched node (e.g., second T-BC node 20-2) might end up selecting a SyncE source from the first branch 5 that is recovered via the IP/MPLS network 14, which may typically be prone to high Packet Delay Variation (PDV). In this case, the SyncE clock from the first branch 5 would not be ideal, especially since a better SyncE source may be available via the second FTS branch 6. Nevertheless, another clock source from the first branch 5 may be better than clock sources from the second branch 6 in some scenarios. Therefore, selection of a clock, according to systems and methods of the present disclosure, are not merely dictated by which upstream branch the clock is coming from.

The following two cases may be applicable to the branched communication system 10 for selecting a master clock source. To summarize the prioritization technique for selecting a clock, a first priority (i.e., shown by the circled “1” in FIG. 1) may be given to a clock source from the Global Navigation Satellite System (GNSS) supplying clock signals to the T-BC-A node 16 in the first branch 5. A second priority (i.e., shown by the circled “2” in FIG. 1) may be given to a clock source from the second branch 6. And lastly, a third priority may be given to a clock source associated with transmission over the IP/MPLS network 14 in the first branch 5. Again, the present disclosure is configured to communicate the source of the clocks from the upstream branches to the second T-BC node 20-2 in order that the clock selection unit 22 can select an “optimal” clock (e.g., lowest time, frequency, or phase offset from an ideal clock) based on the prioritization strategy.

### Prioritizing the Selection of Recovery Clocks

In Case #1, suppose that (a) the T-BC-A node 16 is locked to GNSS, and (b) the first T-BC node 20-1 is locked to the second T-GM node 12-2 directly without any hops in the FTS architecture. In this case, the clock selection unit 22 of the second T-BC node 20-2 can use a standard clock selection algorithm to select its best frequency clock source among two available SyncE sources. In conventional systems, the branched T-BC node 20-2 would not select the PTS-based path in this case, even though it may be considered to be similar to or even better than the SyncE source from the first T-BC node 20-1. Since the better clock might depend on various other factors, the clock selection unit 22 of the present disclosure is configured to use knowledge of clock sources provided by the master components to select the better clock. In this case, the T-BC-A node 16 would have the frequency accuracy similar to a Grand Master and may be given first priority. In some embodiments, it may also be noted that, in the case where one of the sites uses GNSS as a PTP backup (e.g., using PTS or G.8275.2 clock) available over a third party PTP unaware network, while other sites are backed up with PTP from adjacent boundary clocks using G.8275.1, the GNSS source may take priority.

In Case #2, suppose that (a) the T-BC-A node 16 has lost the GNSS clock and is locked to the first T-GM node 12-1 over the IP/MPLS network 14 (e.g., PTS-based), and (b) the first T-BC node 20-1 is locked to the second T-GM node 12-2 without any hops (e.g., FTS-based). In this case, although the T-BC-A node 16 will still be sending SyncE quality level clock signals similar to those sent by the first T-BC node 20-1 to the second T-BC node 20-2, it may be evident that the SyncE clock from the first T-BC node 20-1 is a better choice considering that it uses the FTS network over the entirety of the branch. Although the Quality Level (QL) of the SyncE is the same, the FTS-based SyncE source would be a better selection because it is a hop-by-hop recovered “Physical” frequency source and can thereby reduce impact of the PDV over the IP/MPLS network 14. Thus, the second priority clock takes priority over the third priority clock.

It may be noted that, for the T-BC-A node 16, the IWF module 18 function of converting to SyncE is practically hiding the details from the second T-BC node 20-2. Specifically, the IWF module 18 is hiding the fact that it is recovering frequency over a PTS network. However, since the clock selection unit 22 of the present disclosure is able to obtain additional information about the upstream clock sources, it is configured to use the background knowledge of the PTS nature of the first branch and can better select a clock. It can also be observed that the branched node in the conventional systems may achieve frequency lock but may fail to achieve phase lock due to high PDV through the PTS network. In this case, although the T-BC-A node 16 is frequency-locked and sends PRC QL to the second T-BC node 20-2, the clock selection unit 22 may determine that it may not be desirable to choose this SyncE source over a more stable SyncE source from the first T-BC node 20-1.

Therefore, with the communication from the upstream master clocks, the second T-BC node 20-2 is configured to use the prioritization scheme to determine the best available clock for downstream use. A user in the conventional system could potentially manually configure the first T-BC node 20-1 as having a higher priority than the T-BC-A node 16, but that would mean that even in Case #1, the second T-BC node 20-2 would need to be manually forced to select the SyncE from the first T-BC node 20-1. The manual selection process of the conventional system would, of course, not be desired. Therefore, the clock selection unit 22 of the present disclosure is configured to automatically receive the upstream information regarding clock source to select the best available clock based on prioritization strategies described herein.

### Another System With Clock Synchronization Recovery

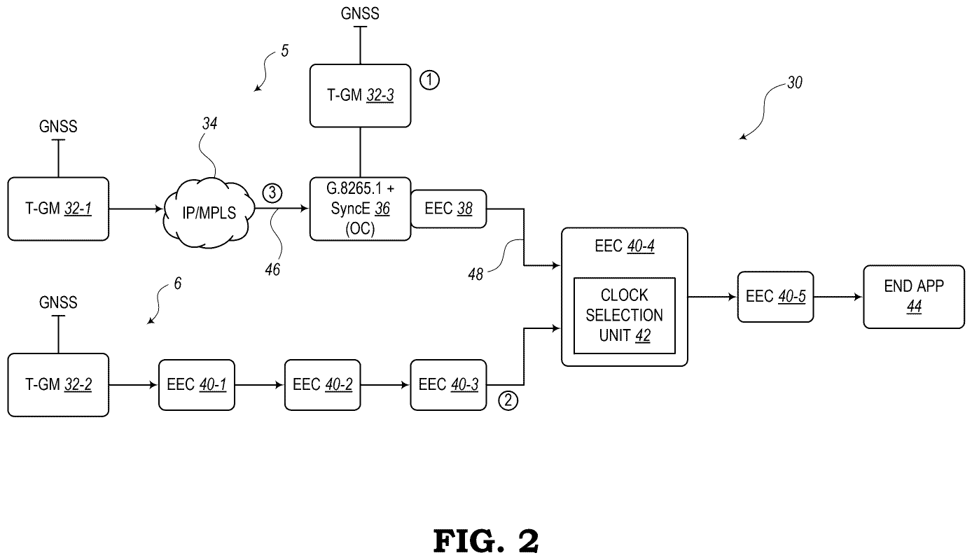

FIG. 2 is a diagram illustrating another embodiment of a branched communication system 30 in which a clock is selected for synchronization recovery. As shown in FIG. 2, the branched communication system 30 includes a first upstream branch comprising a first T-GM node 32-1, an IP/MPLS network 34, a G.8265.1+SyncE node 36, and an Ethernet Equipment Clock (EEC) module 38. The branched communication system 30 also includes a second upstream branch comprising a second T-GM node 32-2, a first EEC node 40-1, a second EEC node 40-2, and a third EEC node 40-3. The SyncE node 36 in the first upstream branch is configured to be synchronized based on a GNSS source connected through a third T-GM node 32-3. The two upstream branches of the branched communication system 30 are joined at a downstream branch comprising a fourth EEC node 40-4 having a clock selection unit 42, a fifth EEC node 40-5, and an end application 44.

In the first (PTS) branch, the IP/MPLS network 34 may provide a G.8275.2 (PTS) PTP backup clock or G. 8265.1 clock to the SyncE node 36 over line 46. The EEC module 38 is configured to provide a SyncE output from the SyncE node 36 to the fourth EEC node 40-4 over line 48. Thus, the fourth EEC node 40-4 is supplied with two SyncE clock sources from the two upstream branches. However, the fourth EEC node 40-4 would not know where these SyncE sources come from without using the strategies described herein.

The clock selection unit 42 of the fourth EEC node 40-4 is configured to determine which upstream clock is to be selected to provide the best synchronization results for the downstream branch during a recovery process. In addition, the clock selection unit 42 may be configured with the same or similar functionality as the clock selection unit 22 shown in FIG. 1 and may be configured to use specific prioritization strategies for determining which clock is the most accurate with respect to time, frequency, and phase. For example, a summarization of a priority scheme may include a first priority (i.e., indicated by the circled “1”) being given to a clock originating from the third T-GM node 32-3. A second priority (i.e., indicated by the circled “2”) may be given to a clock originating from the third EEC node 40-3. A third priority (i.e., indicated by the circled “3”) may be given to a clock originating from the IP/MPLS network 34.

The branched communication system 30 may be applicable to a Frequency Division Duplex (FDD) system, such as a Radio Access Network (RAN) used for wireless communication. For example, the branched communication system 30 may be deployed using an ITU-T Rec. G.8265.1 PTP profile. The following scenario may be applicable in this system arrangement.

### Additional Prioritization Actions

In a Case #3, the SyncE node 36 of the first branch may include an Ordinary Clock (OC) having two frequency sources. A first frequency source may include a SyncE input from the third T-GM node 32-3. A second frequency source may include a Rec. G.8265.1 input from the IP/MPLS network 34 that may be prone to Packet Delay Variation (PDV), whereby the fourth EEC node 40-4 would receive a “packet-based” SyncE input from the G.8265.1 OC via the PDV-prone PTS network. The fourth EEC node 40-4 also receives a SyncE input via a “physical-based” path (e.g., the second branch or FTS branch) from the third EEC node 40-3. The conventional systems may require that the clock be manually selected or may rely on preset assumptions about which branch may be optimal.

However, according to the embodiments described in the present disclosure, the fourth EEC node 40-4 may utilize its clock selection unit 42 to use unique clock selection strategies, as described herein, for prioritizing clocks based on certain criteria. Specifically, the clock selection unit 42 may receive upstream data from master clocks to determine where the operating clocks have come from. Based on this origination information, the clock selection unit 42 can optimally select a clock with desirable characteristics. Such characteristics can include the selected clock having less latency or offsets with respect to time, frequency, and phase. Such characteristics can include the selected clock having consistently good performance over time, e.g. with respect to time, frequency and/or phase accuracy or stability.

For example, the clock selection unit 42 may be configured to place a higher priority on (or prefer) the SyncE input from SyncE node 36 (with OC) when the OC is locked to the SyncE input from the third T-GM node 32-3 since the SyncE input from this source would be more stable than a G.8265.1 frequency input. Also, the clock selection unit 42 may be configured to place a higher priority on (or prefer) the SyncE input from third EEC node 40-3 when the OC of the first branch is locked to the G.8265.1 PTP input over the IP/MPLS network 34 in the case of a SyncE failure from the third T-GM node 32-3. Although both the G.8265.1 OC and the clock of the third EEC node 40-3 would send the same Quality Level (QL) on ESMC packets, it may be evident that the SyncE input from first EEC node 40-1 would be more stable and accurate than the OC. This cannot be achieved in the conventional systems by setting local priority on the fourth EEC node 40-4 as the local priority will enable the fourth EEC node 40-4 to select the SyncE input from OC instead of the clock from the second branch.

### Chart of Ethernet Synchronization Message Channel (ESMC) PDU

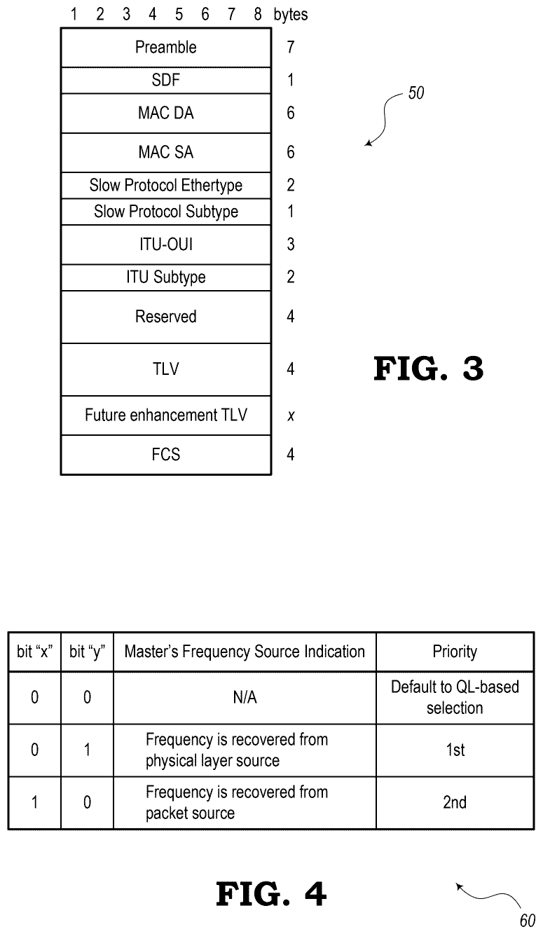

FIG. 3 is a chart 50 showing the Protocol Data Unit (PDU) designation for the Ethernet Synchronization Message Channel (ESMC) as defined in ITU-T Rec. G.8264. It should be noted that the chart 50 includes, among other things, a Type/Length/Value (TLV) field containing four bytes. In addition to predefined TLV characteristics, the ESMC also includes any number of additional bytes that can be utilized in a field referred to as “Future enhancement TLV.” In this section, bits can be inserted in the ESMC by Master clock devices in the two upstream branches of a branched communications system (e.g., branched communications systems 10, 30). According to existing protocols, the ESMC message is transmitted from the upstream Masters for use by the downstream Slaves to help with the selection of available clocks. In the present disclosure, an extension of ITU-T Rec. G.8264 may include additional “prioritization” bits added to the ESMC message. The Slave devices, for example, may include the second T-BC node 20-2 shown in FIG. 1, the fourth EEC node 40-4 shown in FIG. 2, or any other suitable branching nodes that receive multiple available clocks from upstream branches in any suitable communications systems. The Slave devices receives the ESMC message and can select clocks based on the prioritization strategies described in the present disclosure. It is noted that other messaging can be alternatively used.

### Prioritization Strategy

FIG. 4 is a table 60 showing an embodiment a bit designation scheme whereby two bits (e.g., “bit x” and “bit y”) are used for indicating characteristics of a frequency recovery source of a Master node, according to various prioritization strategies described in the present disclosure. The Slave node can analyze the bit designation schemes from multiple upstream Master nodes to determine which clock might be selected. The bit designation scheme may be applicable within previously unused bits of the ESMC message of ITU-T Rec. G.8264.

The Slave node (e.g., the second T-BC node 20-2, the fourth EEC node 40-4, etc.) is configured to receive the information regarding the upstream frequency source of multiple Masters. In particular, the bit designation may be used to indicate whether the clock source for frequency recovery originates from a “packet” layer or a “physical” layer. For example, the packet layer may refer to a source that traverses through an IP/MPLS network (e.g., IP/MPLS network 14, 34) or PTS-based system. A physical layer may refer to a source that traverses through an Ethernet network (e.g., the second branch of the branched communications system 10, the second branch of the branched communications system 30, etc.).

As shown in FIG. 4, the table 60 shows three bit designations, although additional designations with two or more bits may be used for communicating various Master clock scenarios. When bits x and y are both “0” (e.g., low, off, cleared, etc.), no frequency source indication is included. In this case, the selection priority would default to a QL-based selection procedure. For example, according to various embodiments, the QL-based selection may be performed before or after analyzing the bit designations described in the present disclosure. If bit x is “0” and bit y is “1” (e.g., high, on, set, etc.), the ESMC message is intended to indicate that the frequency clock source is recovered from a “physical” layer source over an Ethernet-based line. This would be viewed as having a higher priority (e.g., “first” priority). If bit x is “1” and bit y is “0,” the ESMC message is intended to indicate that the frequency clock source is recovered from a “packet” source over an IP/MPLS network. The Slave node can then use the frequency source indication information for selecting the appropriate frequency recovery clock.

In a first stage, the Master nodes are configured to set the respective x and y bits accordingly based on the clock source used for frequency recovery. This indication of the frequency in the upstream Master branch can be inserted into the two bits in the ESMC packet. For example, the ESMC PDU includes Quality Level (QL) information in the TLV field, which is used to convey quality level to downstream clocks. In some embodiments, two unused bits for frequency source indication may be inserted in the fourth octet of the ESMC message. Also, in some embodiments, the x bit may be the fifth bit in this octet, while the y bit may be the fourth bit (e.g., out of four bits 7, 6, 5, 4).

Again, when bits x, y are set to 00, this is a default setting, where downstream Slave nodes may ignore the bits and rely instead on QL characteristics as an alternative means for selection. When bits x, y are set to 01, the frequency is recovered from a physical layer source (e.g., GNSS, SyncE, 10 MHz, etc.). When bits x, y are set to 10, the frequency source is recovered from a packet source (e.g., G.8275.2 (PTS), G.8265.1 (RAN), etc.).

Other encodings are also possible. For example, one, two or more bits may be set to a particular value to indicate whether the frequency (or other relevant characteristic) is recovered from a physical layer source or from a packet source. Alternatively, such bits may be set to a particular value to indicate the frequency selection priority directly, where the priority is based at least in part on whether the frequency is recovered from a physical layer source or from a packet source.

The downstream Slave can then receive the x, y bit pair (or other indication) for aiding with clock selection techniques. In the case where the received QL is the same for two SyncE sources, the frequency selection priority may rely on the indication of physical frequency source or packet recovered frequency source. This can be used to choose a better SyncE source.

As per ITU G. 781, section 5.12.1, SyncE selection is usually decided over received QL and user set priority. Received “quality level” has the highest priority. In some embodiments, the parameter of “frequency selection priority” (as described herein) can be considered as the second highest analysis step after a QL parameter analysis step. In other embodiments, however, the frequency selection priority may be performed first. If no clear “winner” is found, the strategy may involve using the QL parameter analysis step as the second highest analysis step. If a Slave clock receives the same QL from two different sources, based on the “frequency selection priority” stage, it may select the SyncE source from a Master which is locked to a physical frequency source compared to a Master having frequency source from a packet network.

In some embodiments, the prioritization strategy for selecting a Master clock signal from multiple candidates is governed by each clock's source recovery indicator, which designates whether the clock is recovered from a higher-priority physical layer or from a lower-priority packet layer. As an example, when the source recovery indicator for a first Master clock signal points to a physical layer medium—such as Synchronous Ethernet (SyncE) or another Full Timing Support (FTS) mechanism—while the second Master clock signal's indicator denotes a packet-based frequency recovery (e.g., PTP over IP/MPLS or Partial Timing Support (PTS)), the first Master clock signal may be prioritized. These source recovery indicators can be communicated to downstream nodes by embedding previously unused bits in the Ethernet Synchronization Message Channel (ESMC) Protocol Data Unit (PDU) defined by ITU-T Recommendation G.8264. If both upstream Master clocks share the same Quality Level (QL), the strategy then relies on the source recovery indicators to favor the physical layer source, thereby mitigating higher Packet Delay Variation (PDV) typically encountered in packet-based references. This prioritization can operate before or after a standard QL-based selection procedure, and it is especially beneficial in scenarios where Partial Timing Support (PTS) is converted to Full Timing Support (FTS) via an Inter-Working Function (IWF), but remains “hidden” from downstream elements without explicit source recovery indicators. By integrating these rules into existing selection processes, such as the Best time Transmitter Clock Algorithm (BTCA), the prioritization strategy improves holdover and synchronization recovery, ensuring that more reliable physical-based clock sources are chosen whenever possible.

### Network Element With Synchronization Recovery

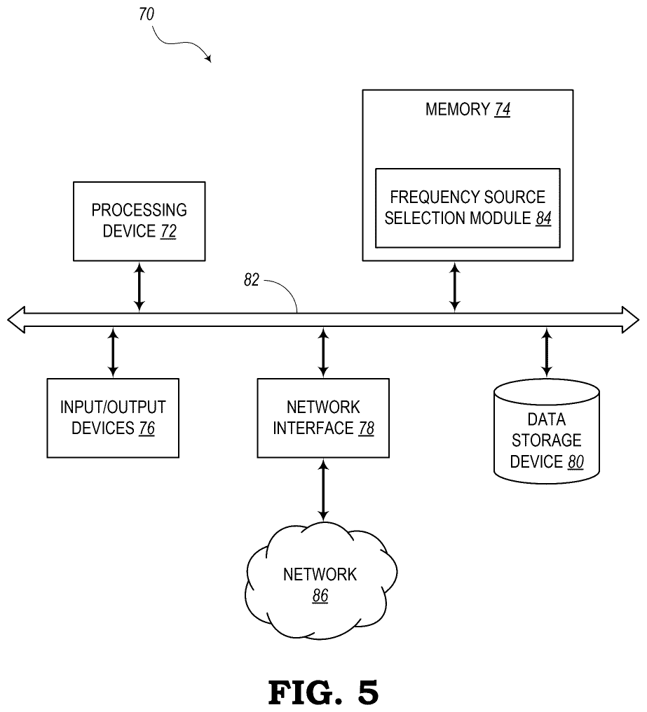

FIG. 5 is a block diagram illustrating an embodiment of a Network Element (NE) 70 operating in a communications network (e.g., branched communication network 10, 30) and configured to select a frequency recovery clock from multiple upstream Master nodes. The NE 70 may operate in an IP network, MPLS network, Ethernet network, mobile/cellular network, or other suitable type of communications network. In particular, the NE 70 may be configured as a Slave node (e.g., the second T-BC node 20-2 in the branched communications system 10, the fourth EEC node 40-4 in the branched communications system 30, etc.). The Slave node may be configured to operate with multiple upstream Master nodes to communicate information about the origination of clock sources for selection by the Slave node.

As shown in the embodiment of FIG. 5, the NE 70 is implemented as a computing device and includes a processing device 72, memory 74, input/output devices 76 (or I/O interfaces), a network interface 78, and a data storage device 80. The processing device 72 may be integrated within the NE 70 or function as a standalone unit connected to the NE 70. It may also be known as an apparatus, a control module, shelf controller, shelf processor, or system controller. The core of the NE 70 may include a processing unit, such as a hardware unit that runs software instructions. The processing unit could be one or more custom or commercially available processors. During operation, the processing unit may execute software from memory 74, manage data communication with the memory 74, and control operations of the NE 70 based on the software.

The network interface 78, possibly an Ethernet device, allows the network element 120 to communicate over a data network and includes necessary connections for address, control, and data communication. The data storage device 80 stores various types of data such as telemetry data, Operations, Administration, Maintenance, and Provisioning (OAM&P) data, etc., and may include both volatile (e.g., RAM) and nonvolatile (e.g., ROM, hard drives) memory elements. Similarly, the memory 74 includes volatile and nonvolatile storage media, potentially employing a distributed architecture where components are located remotely but accessible by the processing device 72. The I/O interface facilitates communication between the NE 70 and external devices.

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs); Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

Furthermore, the NE 70 includes a frequency source selection module 84, which may be implemented in any suitable combination of hardware and/or software. For instance, the frequency source selection module 84 may be stored as computer logic in the memory 74 or other suitable non-transitory computer-readable media and may have instructions allowing the processing device 72 to perform certain procedures, such as those related to selecting frequency clock source or backup clock source as a substitute, recovery clock, or holdover. For example, this selection may be performed when it is determined that a primary source is temporarily unavailable.

### Process for Selecting Backup Clock Source

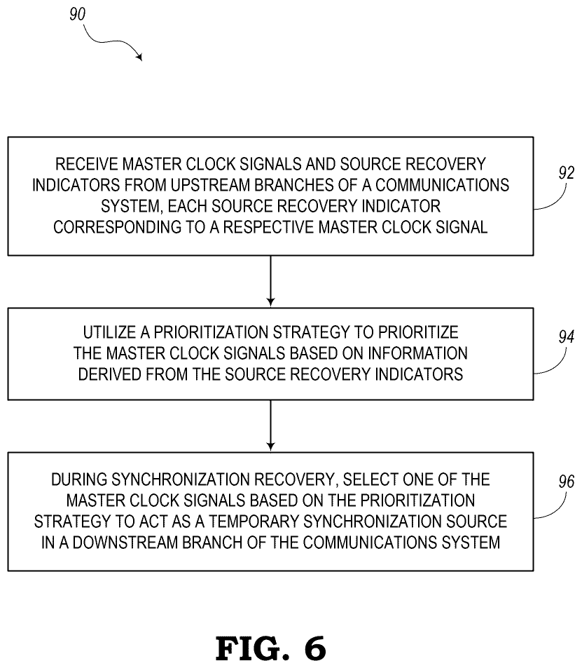

FIG. 6 is a flow diagram illustrating an embodiment of a method 90 for selecting a backup clock source. As shown, the method 90 includes a step of receiving Master clock signals and source recovery indicators from upstream branches of a communications system, as indicated in block 92, where each source recovery indicator corresponds to a respective Master clock signal. The method 90 also includes a step of utilizing a prioritization strategy to prioritize the Master clock signals based on information derived from the source recovery indicators, as indicated in block 94. During synchronization recovery, the method 90 further includes a step of selecting one of the Master clock signals based on the prioritization strategy to act as a temporary synchronization source in a downstream branch of the communications system, as indicated in block 96.

The method 90 may be executed, for example, by a clock selection unit of a Network Element (NE) that is arranged between the upstream branches and downstream branch of the communications system. The NE, for example, may be a Telecom-Boundary Clock (T-BC) device, an Ethernet Equipment Clock (EEC) device, or another suitable type of branching network component.

In some embodiments, the source recovery indicators may be communicated from Master nodes in the upstream branches via an Ethernet Synchronization Message Channel (ESMC) defined in ITU-T Recommendation G.8264. The source recovery indicators, for example, may be inserted by Master nodes into previously unused Type, Length, Value (TLV) bits of a Protocol Data Unit (PDU) of the ESMC. In some embodiments, the source recovery indicators may include two bits in the PDU of the ESMC to designate a first state for indicating a deference to a Quality Lever (QL)-based selection, a second state indicating a frequency recovery from a higher-priority physical layer source, and a third state indicates a frequency recovery from a lower-priority packet source. The source recovery indicators may indicate at least whether the frequency recovery is from a physical layer source or from a packet source.

According to various implementations, the Master clock signals may be identified as being obtained from Synchronous Ethernet (SyncE) sources. The source recovery indicators, for example, may include information regarding a type of frequency source from which the corresponding Master clock signals originate, whereby the type of frequency source may be defined by a medium over which the frequency source is conveyed. The transportation medium, for example, may be a physical layer or a packet layer, where the physical layer may be defined by Ethernet communication according to ITU-T Recommendation G.8275.1 and the packet layer may be defined by Internet Protocol (IP) and/or Multiprotocol Label Switching (MPLS) communication according to ITU-T Recommendation G.8275.2.

The clock selection unit, in some embodiments, may be further configured to temporarily switch to a selected Master clock signal for recovery of clock synchronization when an original clock source between a grand master (GM) clock and a Precision Time Protocol (PTP) client is unavailable. The clock selection unit may be further configured to recover accurate frequency, time, and phase for alignment of the downstream branch with a Grand Master (GM) clock. The clock selection unit, in some embodiments, may further be configured to perform a frequency source recovery by prioritizing a physical-based frequency source over a packet-based frequency source, wherein the physical-based frequency source is communicated over a Full Timing Support (FTS) upstream branch, and wherein the packet-based frequency source is communicated over a Partial Timing Support (PTS) upstream branch. A first branch of the upstream branches, for example, may include an Inter-Working Function (IWF) component that converts Partial Timing Support (PTS) to Full Timing Support (FTS), where the first branch might be prone to high Packet Delay Variation (PDV), and where conversion from PTS to FTS is hidden from the downstream branch without knowledge of the source recovery indicators.

According to some embodiments, the clock selection unit may further be configured to default to a clock selection based on Quality Level (QL) before utilizing the prioritization strategy, where the clock selection unit may then perform the prioritization strategy when the QL of the upstream branches is the same. Alternatively, the clock selection unit may be configured to default to a clock selection based on QL after utilizing the prioritization strategy, where a QL analysis may be performed when execution of the prioritization strategy for the upstream branches results in equal priorities. In some embodiments, the method 90 may be defined whereby the process of utilizing the prioritization strategy and selecting a Master clock signal may be configured as an enhancement to the Best time Transmitter Clock Algorithm (BTCA).

### Additional Considerations

The systems and methods of the present disclosure include various points of novelty with respect to conventional systems. For example, various embodiments described herein are configured to utilize two bits in the ESMC PDU (FIG. 3) that are currently unused bits. These two bits may be inserted in the QL section of the TLV of the ESMC PDU to indicate the frequency source of a Master clock. Multiple upstream Master clocks may be configured to set the two bits accordingly to indicate their respective sources. A downstream Slave can then obtain the multiple source indication data (embedded in the previously unused spaces of ESMC message) and select a clock source based on which one would provide the best synchronization results. Corresponding modification to the functionality of the clock selection units 22, 42 in the Slave nodes can be made to help clients choose a better frequency source and to do so automatically. Clock Selection Algorithms (CSAs) of the clock selection units 22, 42 can be modified accordingly to assist with selecting a “better” clock (e.g., less frequency offset).

Conventional solutions would normally need manual user intervention to configure a fixed priority. This might be done at the client node for each available Master. Based on this priority, a specific Master can be selected. This might happen every time, wherever there is clock source change on the Master. Of course, these conventional systems are not dynamic and are unable to provide the benefits of the systems and methods of the present disclosure. That is, the conventional systems do not allow clients to choose frequency source based on upstream conditions to its available Masters. Clients using the conventional system may then end up selecting frequency sources from high PDV-prone IP/MPLS network, instead of switching to a better “physical” recovered (e.g., Ethernet) frequency source as is made possible by the systems and methods of the present disclosure.

The current implementations described herein may use two (or more) bits in the QL TLV inside the ESMC PDU to indicate the Master's frequency reference source. Again, this may help downstream clients to choose a better SyncE reference dynamically via information coming from Master. The present disclosure therefore proposes a new clock parameter, which may be incorporated into the ESMC PDU standard and may be referred to as a “frequency selection priority” technique by using the two bits in ESMC PDU to designate various source conditions or characteristics. This new clock parameter may be considered in the clock selection criteria of NEs used throughout a communications network for selecting a highest prioritized clock source.

The systems and methods described herein may provide any number of benefits or advantages over traditional systems. The current embodiments may improve robustness of clocking in packet networks when used with various communications products and systems. It also can help network operators build clock resilient networks without needing detailed planning that would involve prior knowledge of different frequency sources that might be applicable in a network.

It may be noted that the novelty of the various embodiments of the present disclosure may be associated with prioritization of more reliable clock sources, which in turn may be based on the calculation of asymmetry values, variation values, variability values, synchronization offset values, or the like. An offset in clock synchronization of potential backup clocks may be analyzed with respect to a grandmaster clock source or other suitable primary clock source. Consideration of some variability factors (e.g., peak-to-peak asymmetry or variation) in the BTCA may be used to select the best available backup at run time.

A Telecom Grandmaster (T-GM) may be configured as a specialized grandmaster clock used in telecommunications networks that implement PTP. Specifically defined in recommendations like ITU-T G.8275.1 and G.8275.2, the T-GM serves as the primary source of precise time and phase synchronization for telecom networks requiring high levels of accuracy. In the context of PTP, the T-GM may be configured to distribute accurate timing information to downstream network elements, such as Telecom Boundary Clocks (T-BCs) and Telecom Time Slave Clocks (T-TSCs). The T-GM may be configured to interface with a highly accurate reference time source, typically a Global Navigation Satellite System (GNSS), such as GPS. The T-GM may then use PTP to propagate this timing information across the network, ensuring that all devices are synchronized to the same precise time. The T-GM is designed to meet the stringent synchronization requirements of modern telecom applications, such as 4G LTE-Advanced and 5G networks.

The BTCA in ITU-T G.8275.2 plays a vital role in ensuring robust time synchronization in networks with Partial Timing Support (PTS). G.8275.2 addresses scenarios where not all network elements provide full timing support, i.e., the PTS, making it more challenging to maintain synchronization accuracy. The BTCA is designed to select the Best Time Transmitter (BTT) among multiple PTP clocks available in the network 10. It evaluates various parameters, such as those contained in PTP Announce messages, including clock priority, clock quality, and stability, to determine the most reliable source of timing. In a PTS environment, where some nodes may lack full synchronization support, the BTCA ensures that nodes can make informed decisions about which time source to use. Unlike the Best Master Clock Algorithm (BMCA), the BTCA incorporates a stronger focus on the quality of frequency backup and the reliability of timing inputs, which is critical for networks prone to disruptions or partial support scenarios. By selecting the most stable and accurate clock, the BTCA enhances the resilience of synchronization systems in G.8275.2 networks, ensuring continuity and precision in time distribution even when full timing support is unavailable. The Alternate Best Time Clock Algorithm (A-BTCA) is a variation of the BTCA designed to enhance timing resilience by incorporating additional criteria, such as topology awareness or specific network conditions, for selecting the Best Time Transmitter, whereas the standard BTCA primarily focuses on predefined parameters like clock quality and frequency backup, without accounting for network-specific factors.

With respect to the terms master and grandmaster, a grandmaster clock, e.g., the T-GM, is the primary source of time for the network. It is chosen based on its superior clock quality, stability, and attributes such as priority and accuracy. The grandmaster is responsible for providing the reference time to all other clocks in the network, which synchronize with it to maintain accurate timing. A master clock, on the other hand, is any clock in the network that is actively distributing timing information to other clocks (slaves) within its domain. While the grandmaster clock is always a master clock, not all master clocks are grandmaster clocks. For instance, in certain network configurations or holdover scenarios, a local node might become a master clock temporarily, distributing time to nearby devices even though it is not the primary reference (GMC). In BTCA, the distinction becomes significant during degraded scenarios or holdover periods. The algorithm may select a master clock to act as the active timing source based on its relative stability and quality in that specific context, even if it is not the original grandmaster. This ensures that timing accuracy is preserved as much as possible, especially in networks with Partial Timing Support (as in G.8275.2). Thus, while the grandmaster is the preferred ultimate time source, BTCA allows for flexibility in selecting an alternative master clock based on the best available timing conditions. The present disclosure addresses improvements in BTCA for selecting the master clock during disruptions to the grandmaster, for purposes of improving holdover.

In the network, the T-GMs and the T-BCs may be located at nodes or network elements, or links interconnecting the nodes or network elements, or a combination thereof. The T-BCs may have a backup local Synchronous Ethernet (SyncE) clock other than its congruent primary PTP connection to the T-GM, thus if the T-BC loses the PTP connection (e.g., due to degradation or other cause), it still has its Primary Reference Clock (PRC) traceable to the SyncE clock. However, as mentioned throughout the present disclosure, the conventional BTCA does not normally check variability factors (e.g., peak-to-peak variability of a waveform created by data points over time).

The Ethernet Synchronization Messaging Channel (ESMC) is a logical communication channel used in Synchronous Ethernet (SyncE) networks to exchange information about the quality level of a clock source, which may be known as “Synchronization Status Messages” (SSMs). The ESMC allows network devices to select the most reliable timing source across the network. Essentially, it is a dedicated channel within an Ethernet network for managing clock synchronization data between devices.

ESMC may allow the transmission of SSMs, which may contain QL values indicating the accuracy of a device's clock. ESMC, for example, is generally defined by the ITU-T G.8264 standard, but may be extended to include the upstream clock source origination information as described in the present disclosure. ESMC may use an Ethernet protocol to carry SSMs within the network and may help network devices to choose the best timing source by providing information about the quality of clocks throughout the network, preventing timing loops or other issues.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A Network Element (NE) arranged in a communications system between upstream branches and a downstream branch, the NE having a clock selection unit configured to:
receive Master clock signals and source recovery indicators from the upstream branches, each source recovery indicator corresponding to a respective Master clock signal;
utilize a prioritization strategy to prioritize the Master clock signals based on information derived from the source recovery indicators; and
during synchronization recovery, select one of the Master clock signals based on the prioritization strategy to act as a temporary synchronization source in the downstream branch.

2. The NE of claim 1, wherein the source recovery indicators are communicated from Master nodes in the upstream branches via an Ethernet Synchronization Message Channel (ESMC) defined in ITU-T Recommendation G.8264, the source recovery indicators being inserted by Master nodes into previously unused Type, Length, Value (TLV) bits of a Protocol Data Unit (PDU) of the ESMC.

3. The NE of claim 2, wherein the source recovery indicators include two bits in the PDU of the ESMC to designate a first state for indicating a deference to a Quality Lever (QL)-based selection, a second state indicating a frequency recovery from a higher-priority physical layer source, and a third state indicates a frequency recovery from a lower-priority packet source.

4. The NE of claim 1, wherein the Master clock signals are identified as being obtained from Synchronous Ethernet (SyncE) sources.

5. The NE of claim 1, wherein the source recovery indicators include information regarding a type of frequency source from which the corresponding Master clock signals originate, the type of frequency source being defined by a medium over which the frequency source is conveyed, and wherein the medium is a physical layer or a packet layer.

6. The NE of claim 1, wherein the clock selection unit is further configured to temporarily switch to a selected Master clock signal for recovery of clock synchronization when an original clock source between a grand master (GM) clock and a Precision Time Protocol (PTP) client is unavailable.

7. The NE of claim 1, wherein the clock selection unit is further configured to recover accurate frequency, time, and phase for alignment of the downstream branch with a Grand Master (GM) clock.

8. The NE of claim 1, wherein the clock selection unit is further configured to perform a frequency source recovery by prioritizing a physical-based frequency source over a packet-based frequency source.

9. The NE of claim 1, wherein a first branch of the upstream branches includes an Inter-Working Function (IWF) component that converts Partial Timing Support (PTS) to Full Timing Support (FTS), the first branch being prone to high Packet Delay Variation (PDV), and wherein conversion from PTS to FTS is hidden from the downstream branch without knowledge of the source recovery indicators.

10. The NE of claim 1, wherein the clock selection unit is further configured to default to a clock selection based on Quality Level (QL) before utilizing the prioritization strategy and performing the prioritization strategy when the QL of the upstream branches is the same.

11. The NE of claim 1, wherein the clock selection unit is further configured to default to a clock selection based on Quality Level (QL) after utilizing the prioritization strategy and performing a QL analysis when execution of the prioritization strategy for the upstream branches results in equal priorities.

12. The NE of claim 1, wherein a process of utilizing the prioritization strategy and selecting a Master clock signal is configured as an enhancement to Best timeTransmitter Clock Algorithm (BTCA) defined in IEEE 1588 (Precision Time Protocol (PTP)).

13. The NE of claim 1, wherein the NE is a Telecom—Boundary Clock (T-BC) device or an Ethernet Equipment Clock (EEC) device.

14. A Master node arranged in an upstream branch of a communications system, the Master node configured to provide a clock signal and a source recovery indicator to a downstream Network Element (NE) that is configured to receive multiple clock signals and multiple source recovery indicators from multiple Master nodes operating on multiple upstream branches of the communications system, wherein the multiple source recovery indicators enable the NE to utilize a prioritization strategy to prioritize the multiple clock signals based on information derived from the multiple source recovery indicators, such that, during synchronization recovery, the NE is configured to select one of the multiple clock signals based on the prioritization strategy to act as a temporary synchronization source in a downstream branch of the communications system.

15. The Master node of claim 14, further configured to insert the source recovery indicator into previously unused Type, Length, Value (TLV) bits of a Protocol Data Unit (PDU) of Ethernet Synchronization Message Channel (ESMC) defined in ITU-T Recommendation G.8264 and communicate the PDU to the NE.

16. A method comprising steps of:
receiving Master clock signals and source recovery indicators from upstream branches of a communications system, each source recovery indicator corresponding to a respective Master clock signal;
utilizing a prioritization strategy to prioritize the Master clock signals based on information derived from the source recovery indicators; and
during synchronization recovery, selecting one of the Master clock signals based on the prioritization strategy to act as a temporary synchronization source in a downstream branch of the communications system.

17. The method of claim 16, wherein the step of receiving the source recovery indicators includes receiving the source recovery indicators via an Ethernet Synchronization Message Channel (ESMC) defined in ITU-T Recommendation G.8264, the source recovery indicators being inserted by Master nodes into previously unused Type, Length, Value (TLV) bits of a Protocol Data Unit (PDU) of the ESMC.

18. The method of claim 17, wherein the source recovery indicators include two bits in the PDU of the ESMC to designate a first state for indicating a deference to a Quality Lever (QL)-based selection, a second state indicating a frequency recovery from a higher-priority physical layer source, and a third state indicates a frequency recovery from a lower-priority packet source.

19. The method of claim 16, wherein the Master clock signals are identified as being obtained from Synchronous Ethernet (SyncE) sources.

20. The method of claim 16, wherein the source recovery indicators include information regarding a type of frequency source from which the corresponding Master clock signals originate, the type of frequency source being defined by a medium over which the frequency source is conveyed, and wherein the medium is a physical layer or a packet layer.
